(19) United States
(12) Patent Application Publication
(10) Pub. No.: US 2018/0260719 A1
(43) Pub. Date: Sep. 13, 2018

(54) CASCADED RANDOM DECISION TREES USING CLUSTERS

(71) Applicant: Microsoft Technology Licensing, LLC, Redmond, WA (US)

(72) Inventors: Aditya Vithal Nori, Cambridge (GB); Antonio Criminisi, Cambridge (GB); Loïc Le Folgoc, Cambridge (GB)

(21) Appl. No.: 15/456,473

(22) Filed: Mar. 10, 2017

(51) Int. Cl. G06N 5/04; G06N 99/00

(52) U.S. Cl. CPC G06N 5/04; G06N 99/005

(57) ABSTRACT

A machine learning system is described which has a memory storing at least one trained random decision tree and parameters of a plurality of clusters associated with the trained random decision tree. A processor of the machine learning system pushes a sensor data element through the trained random decision tree to compute a prediction and to obtain values of features associated with the sensor data element. The processor selects one of the clusters by comparing the features associated with the received sensor data element and the parameters of the clusters. The memory stores at least one cluster-specific random decision tree, which has been trained using data from the selected cluster. The processor is configured to push the prediction through the cluster-specific random decision tree to compute another prediction. The clusters group together sensor data elements which give rise to similar pathways when pushed through the trained random decision tree.

### BACKGROUND

Machine learning technology using random decision trees and random decision forests, which are collections of random decision trees, is used for a variety of tasks such as gesture recognition, object recognition, automatic organ detection, speech recognition and other tasks. However, where the task is complex the resulting random decision trees and/or forests are often very deep (many layers of nodes) and/or large in number (many hundreds of trees and/or forests are used). This means that at test time, when the trained machine learning system is used to analyze incoming sensor data, the time to compute the analysis is often lengthy especially where conventional computing resources are used. In the case of medical professionals waiting for organ detection results on a medical image, the length of time for the analysis can be several minutes which is unacceptable in many situations. In the case of gesture recognition used to control a computing device, the gestures are to be detected in real time in order to enable practical control of the computing device and this also applies to speech recognition and other applications.

Such machine learning systems often have limited accuracy and/or generalization ability. Generalization ability is being able to accurately perform the task in question even for examples which are dissimilar to those used during training.

Large numbers of training examples are typically used to train random decision trees or random decision forests in order to carry out classification tasks such as human body part classification from depth images or gesture recognition from human skeletal data, or regression tasks such as joint position estimation from depth images. The training process is typically time consuming and resource intensive.

The embodiments described below are not limited to implementations which solve any or all of the disadvantages of known random decision trees.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

A machine learning system is described which has a memory storing at least one trained random decision tree and parameters of a plurality of clusters associated with the trained random decision tree. A processor of the machine learning system pushes a sensor data element through the trained random decision tree to compute a prediction and to obtain values of features associated with the sensor data element. The processor selects one of the plurality of clusters by comparing the features associated with the received sensor data element and the parameters of the clusters. The memory stores at least one cluster-specific random decision tree, which has been trained using data from the selected cluster. The processor is configured to push the prediction through the cluster-specific random decision tree to compute another prediction. The clusters group together sensor data elements which give rise to similar pathways when pushed through the trained random decision tree.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a plurality of different systems in which a machine learning system with a cascade of random decision trees/forests is used;

FIG. 2 is a schematic diagram of a cascade of random decision trees/forests and showing cluster selection;

FIG. 3 is a schematic diagram of a random decision tree used to classify image patches from two photographs as belonging to grass, cow or sheep classes;

FIG. 4 is a flow diagram of a method of training a cascade of random decision trees/forests;

FIG. 5 is a flow diagram of part of the method of FIG. 4 in more detail;

FIG. 6 is a flow diagram of a method of using a trained cascade of random decision trees/forests at test time;

FIG. 7 is a flow diagram of part of the method of FIG. 6 in more detail;

FIG. 8 illustrates an exemplary computing-based device in which embodiments of a cascade of random decision trees/forests, and/or a training logic for training the cascade of random decision trees/forests are implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example are constructed or utilized. The description sets forth the functions of the example and the sequence of operations for constructing and operating the example. However, the same or equivalent functions and sequences may be accomplished by different examples.

Although the present examples are described and illustrated herein as being implemented in an image patch classification system, the system described is provided as an example and not a limitation. As those skilled in the art will appreciate, the present examples are suitable for application in a variety of different types of image processing or machine learning systems. A machine learning system is a computer-implemented apparatus which is able to learn from examples either during an online training process or through offline training by updating data structures using update procedures in the light of the examples.

A cascade of random decision forests comprises one or more levels where output of an earlier level is used as input to a subsequent level and where a level comprises at least one random decision forest. A cascade of random decision trees (as opposed to forests) comprises one or more levels where output of an earlier level is used as input to a subsequent level and where a level comprises at least one random decision tree. In a cascade of random decision forests (or a cascade of random decision trees) the original input data is optionally available to subsequent layers. In the case where the subsequent layer(s) have more than one random decision tree/forest the individual random decision trees or forests may be trained using clustered training data. In this way a random decision tree/forest trained using a cluster of data becomes specialized with respect to that cluster of data, as compared with other random decision trees/forests trained with other clusters of training data.

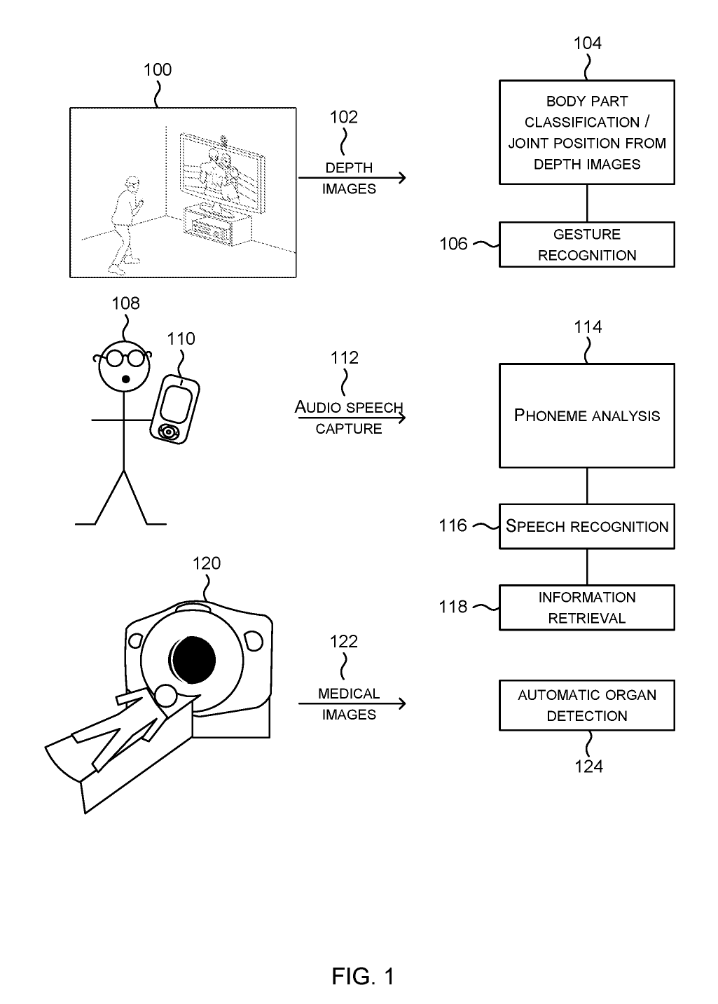

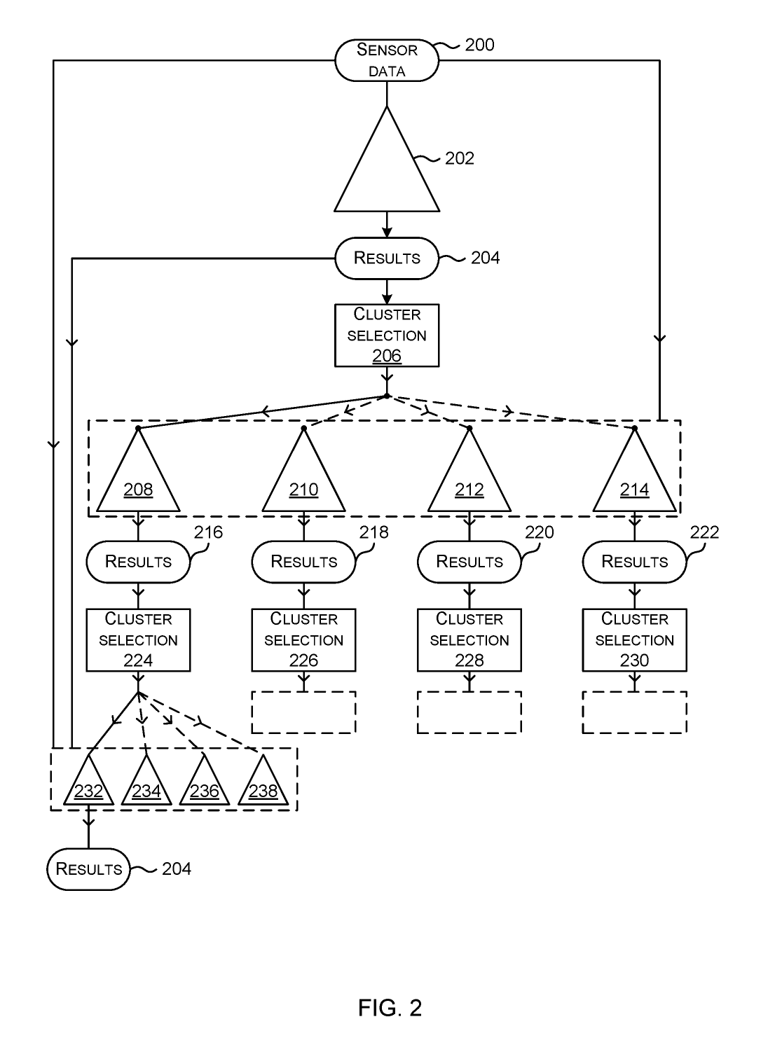

Using a cascade of random decision trees/forests brings reduced computation at test time as compared with an equivalent random decision tree/forest which is not cascaded. This is because fewer nodes are traversed when the sensor data elements are processed by the cascade of random decision forests as explained in more detail below with reference to FIG. 2. In the case that a cascade of random decision trees/forests is used it is difficult to find ways to automatically divide the training data and create the clusters so as to enable the specialized trees/forests to be trained and produce accurate results. Due to the quantity and nature of the data it is typically not possible to use human judges to divide the training data by making semantic judgments. In various examples described herein, the clusters are formed by clustering training data examples according to pathways of those examples through a trained first level random decision tree. It is found empirically that using clustering in this manner gives accurate results and good generalization ability. The cascade of random decision trees or forests is used for a variety of different types of application as described with reference to FIG. 1.

FIG. 1 is a schematic diagram of a plurality of systems in which a machine learning system with a cascade of random decision trees/forests is used. For example, a body part classification or joint position detection system 104 operating on depth images 102. The depth images may be from a natural user interface of a game device as illustrated at 100 or may be from other sources. The body part classification or joint position information may be used to calculate gesture recognition 106.

In another example, a person 108 with a smart phone 110 sends an audio recording of his or her captured speech 112 over a communications network to a machine learning system 114 that carries out phoneme analysis. The phonemes are input to a speech recognition system 116 which uses a cascade of random decision trees/forests. The speech recognition results are used for information retrieval 118. The information retrieval results may be returned to the smart phone 110.

In another example medical images 122 from a computerized tomography (CT) scanner 120, medical resonance imaging (MRI) apparatus or other device are used for automatic organ detection 124.

In the examples of FIG. 1 a machine learning system using a cascade of random decision trees/forests is used for classification or regression. This gives better accuracy and/or speed of performance as compared with previous systems using equivalent architectures with non-cascaded random decision trees/forests.

A random decision tree comprises a root node, a plurality of split nodes and a plurality of leaf nodes. The root node is connected to the split nodes in a hierarchical structure, so that there are layers of split nodes, with each split node branching into a maximum of two nodes and where the terminal nodes are referred to as leaf nodes. Each split node has associated split node parameters. Values of split node parameters are learnt during training. During training, labeled training data accumulates at the leaf nodes and is stored in an aggregated form.

In the case of image processing, image elements of an image may be pushed through a trained random decision tree in a process whereby a decision is made at each split node. The decision may be made according to characteristics of the image element and characteristics of test image elements displaced therefrom by spatial offsets specified by the parameters at the split node. At a split node the image element proceeds to the next level of the tree down a branch chosen according to the results of the decision. This process continues until a leaf node is reached and distributions of labeled image elements which were accumulated at the leaf node during training are retrieved and used to compute a prediction such as a predicted label for the test image element.

Other types of examples may be used rather than images. For example, phonemes from a speech recognition pre-processing system, or skeletal data produced by a system which estimates skeletal positions of humans or animals from images. In this case test examples are pushed through the random decision tree. A decision is made at each split node according to characteristics of the test example and of a split function having parameter values specified at the split node.

The examples comprise sensor data, such as images, or features calculated from sensor data, such as phonemes or skeletal features.

An ensemble of random decision trees may be trained and is referred to collectively as a random decision forest. At test time, image elements (or other test examples) are input to the trained forest to find a leaf node of each tree. Data accumulated at those leaf nodes during training may then be accessed and aggregated to give a predicted regression or classification output. Due to the use of random selection of possible candidates for the split node parameters during the training phase, each tree in the forest has different parameter values and different accumulated data at the leaf nodes. By aggregating the results across trees of the forest improved accuracy and generalization ability is found.

FIG. 2 is a schematic diagram of a cascade of random decision trees. The example of FIG. 2 may be modified by replacing the random decision trees by random decision forests. Sensor data 200 such as a depth image, a color image, a medical image, an audio file, or other sensor data is available for input to a first level random decision tree 202. The first level random decision tree 202 has already been trained (as described later in this document) and computes one or more results 204 which are predictions comprising numerical values such as predicted class labels of image elements, predicted joint positions of joints of a person depicted in a depth image, predicted hand poses of hands of a person depicted in a color image, predicted body organ labels of body organs depicted in a medical image, predicted phonemes of a speech signal, or other predictions.

During processing of the sensor data 200 by the first layer random decision tree 202 features of the sensor data 200 are computed. These features are used by a cluster selection process 206 to select one of a plurality of first level clusters which were computed during a training phase of the first level random decision tree (as described in more detail later in this document). The clusters are formed using similarity of pathways of training examples through the first layer random decision tree 202. The cluster selection process 206 compares the features with parameters of the first level clusters, to find a first level cluster with similar parameters to the features, in order to make the selection. A cluster is a plurality of sensor data items each represented by a feature vector. The parameters of a cluster are statistics describing the cluster, such as mean values of the features of members of the cluster, a variance of values of a feature of the cluster or other statistics. Any comparison process may be used such as computing the difference between features and the parameters, or checking whether the features and the parameters are within a specified range of one another in terms of magnitude or other qualities.

Associated with each first level cluster is at least one first level cluster-specific random decision tree 208, 210, 212, 214. Each cluster-specific random decision tree has been trained using data from the associated cluster. In this way each cluster-specific random decision tree becomes specialized with respect to data in the associated first level cluster. In the example of FIG. 2 there are four first level clusters (not shown) formed from training data of the first random decision tree 202. The cluster selection process 206 has selected one of those four first level clusters where the selected cluster has been used to train cluster-specific random decision tree 208. The cluster selection process 206 is able to switch between the individual first level cluster-specific random decision trees as indicated in FIG. 2 where the dotted lines to random decision trees 210, 212, 214 indicate these random decision trees are not currently selected, whereas random decision tree 208 is currently selected.

The results 204 from the first level random decision tree are input to the selected first level cluster-specific random decision tree (such as tree 208 in the example of FIG. 2). In addition the sensor data 200 is available as input to the selected cluster-specific random decision tree.

The selected cluster-specific random decision tree 208 computes results 216 comprising predicted values such as predicted class labels of image elements, predicted joint positions of joints of a person depicted in a depth image, predicted hand poses of hands of a person depicted in a color image, predicted body organ labels of body organs depicted in a medical image, predicted phonemes of a speech signal, or other predictions. The results 216 from the first level cluster-specific random decision tree are more accurate than those from the first level random decision tree because more computation has been done to refine the results 204 using the first level cluster-specific random decision tree. This increased accuracy is achieved whilst keeping the amount of computation at test time reduced. For example, to achieve a same level of accuracy without using a cascaded architecture, a single random decision tree would be trained using the same training data but having a greater depth (and breadth?) than the aggregated depth of the random decision trees 202 and 208. Traversing the resulting tree at test time is then computationally expensive and time consuming. In the case that forests are used the architecture without cascading comprises a single random decision forest with many deep trees (such as many hundreds of deep trees). This is computationally expensive at test time since each tree in the forest is traversed to compute predictions which are then aggregated. In contrast, where cascading is used, forests with fewer trees and shallower trees are traversed at test time.

The cluster-specific cascading may repeat for further levels. For example, FIG. 2 shows the results from the first level cluster-specific random decision tree 208 being input to a second level cluster selection process 224. This cluster selection process selects one of a plurality of clusters (in this case four clusters) which have been computed in a training phase using training data used to train the first level cluster-specific random decision tree 208. The second level clusters are computed using a similarity metric related to the similarity of pathways through the first level cluster-specific random decision tree 208. In this example, the selected second level cluster is associated with second level cluster-specific random decision tree 232. The second level cluster-specific random decision tree 232 also takes input from the original sensor data 200 and the results 204 of the first level random decision forest.

In various examples, the functionality of one or more of the components of FIG. 2 is performed, at least in part, by one or more hardware logic components. For example, and without limitation, illustrative types of hardware logic components that are optionally used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

The cascaded architecture of FIG. 2 is used in some examples for image processing, such as for object recognition in videos, depth images, color images and automatic organ detection in medical images. In this case each level of the cascade is arranged to compute a progressively refined region of interest, starting from an initial over approximation of the region of interest (e.g. the full image) and training downstream trees/forests on more refined regions of interest that exclude irrelevant background clutter, thereby increasing accuracy. Such an approach runs the risk of excluding false negatives, creating a trade-off between coarser regions of interest (high recall) and tighter regions of interest (high precision). However, it is found that by using the clustering approach described herein, where the clusters are formed using similarity of pathways in the immediately preceding layer of the cascade, it is possible to circumvent the above mentioned limitation. In this way accuracy is improved.

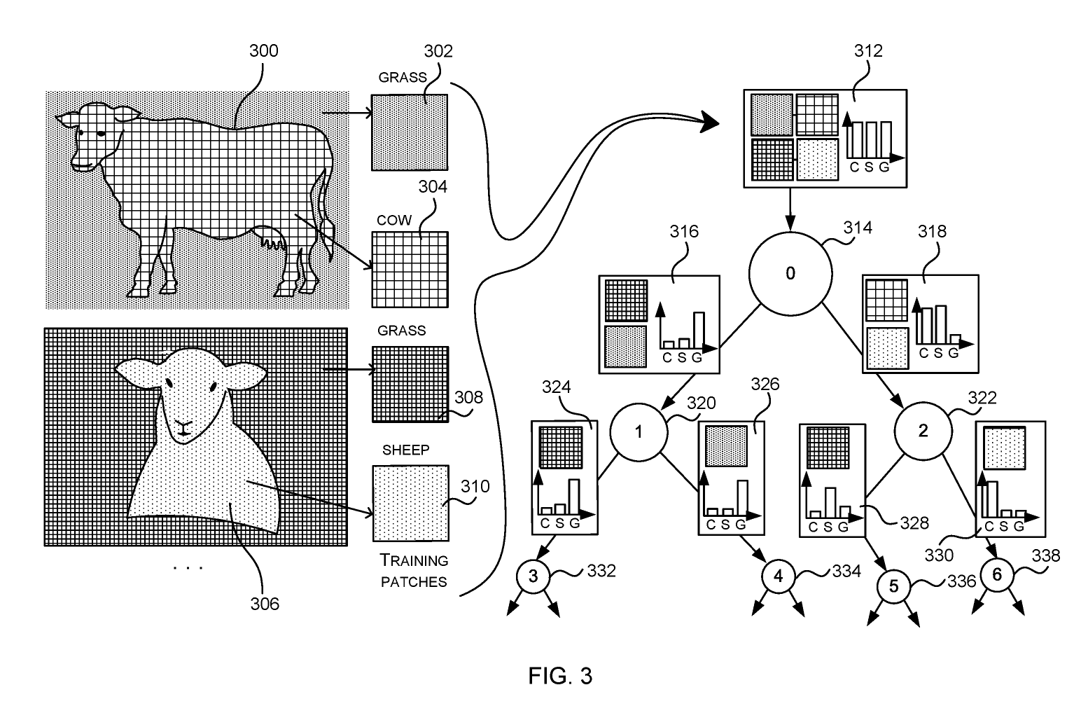

FIG. 3 is a schematic diagram of a random decision tree used to classify image patches from two photographs as belonging to grass, cow or sheep classes. This example illustrates how values of parameters of split functions used at the split nodes influence pathways of sensor data through the random decision tree at test time. It is recognized herein that pathways of sensor data through the random decision tree at test time may be similar for semantically similar sensor data and this is illustrated in FIG. 3. The clusters in the cascaded random decision tree/forest architecture are then formed by using data about pathways of sensor data through the random decision tree/forest. This is found empirically to give particularly accurate results.

A photograph of a cow 300 standing in a grassy field is represented schematically in FIG. 3. A photograph of a sheep 306 sitting in a different grassy field is also represented schematically in FIG. 3. Four image patches 302, 304, 308, 310 are taken from the photographs and are input to a trained random decision tree for classification as belonging to grass, cow or sheep classes. The image patches have different color, intensity and texture from one another. The image patch 302 from the grass in the cow photograph is a different from the image patch 308 from the grass in the sheep photograph.

The image patches are input to a root node 314 of the random decision tree as indicated at 312. A parameterized split function at the root node is applied to the image patches and results in the grass patch 308 from the sheep photograph and the grass patch 302 from the cow photograph 302 being input to node 320 as indicated at 316. The cow patch 304 and the sheep patch 310 are input to node 322 as indicated at 318. FIG. 3 shows a histogram at each of the split nodes. These are normalized histograms of the training labels reaching these nodes.

Parameterized split functions at each of split nodes 320 and 322 are applied. This results in the grass patch from the sheep photograph reaching node 332 as indicated at 324 and the grass patch from the cow photograph reaching node 334 as indicated at 326. The sheep patch reaches node 336 as indicated. The cow patch reaches node 330 as indicated. Thus the values of the parameters of the split functions are important for determining pathways of the sensor data through the random decision forest. The values of the parameters of the split functions are learnt during training where training images patches are used which are labeled according to whether they depict sheep, cow or grass. It is recognized herein that the pathways of test image patches, at test time, tend to be similar for semantically similar image patches. For example, the grass patches 302, 308 are semantically similar as these both depict grass. The pathway at test time for the grass patch 302 from the cow image is from node 0 to node 1 and then to node 4. The pathway at test time for the grass patch 308 from the sheep image is from node 0 to node 1 and then to node 3. These pathways have two nodes in common, that is nodes 0 and 1. In another example, the cow patch 304 and sheep patch 310 are semantically similar as these both depict a farm animal. The test time pathways of FIG. 3 for the cow patch 304 and the sheep patch 310 have two nodes in common, nodes 0 and node 2. In contrast, the test time pathways of FIG. 3 for the cow patch 304 and the grass patch from the sheep image 310 have only one node in common, which is the root node. These two patches are less semantically similar than the two grass patches, or the two farm animal patches, and so the pathways at test time are less similar.

Various embodiments described herein make use of the realization that similar pathways in a trained random decision tree tend to be taken by semantically similar sensor data. Clusters In various embodiments a similarity metric is computed which measures how similar two pathways are through the same random decision tree at test time. Each pathway begins at the root node and ends at a leaf node. Where trees (rather than forests are used) the metric is computed per tree. Where forests are used the metric is computed for each tree in the forest and then aggregated by addition, averaging, or in other ways.

Various different similarity metrics may be used which are able to measure how similar two pathways are through the same random decision forest. In some examples the metric is related to the number of nodes which are the same in each pathway. In some examples the metric is related to the depth of the deepest node in each pathway which is common to both pathways. In some examples the metric is inversely related to the depth of the deepest node common to both pathways or inversely related to the number of nodes which are the same in each pathway. In some examples the metric is expressed formally as:

$$S ( {x}_{i} , {x}_{j} ) {=}^{Δ} {\sum }_{t = 1}^{T} {( \frac{1}{2} )}^{{depth}_{t}^{T} ( {x}_{i} , {x}_{j} )}$$

Which is expressed in words as the similarity of two sensor data elements expressed as feature vectors xᵢ, xⱼ is defined as the sum over the number of random decision trees tin random decision forest T as one half to the power of the depth of the deepest common node in both paths.

In some examples the metric takes into account other factors in addition to similarity of pathways. For example, similarity of feature vectors of the sensor data elements and/or similarity of predictions computed from the first level random decision forest using the sensor data elements. For example, a Euclidean or other distance metric is computed between feature vectors of the sensor data elements, where those feature vectors are concatenated with the associated predictions from the first level tree. The results from the distance metric may be combined with results from computation of similar pathways by aggregation such as weighted averaging, addition or in other ways.

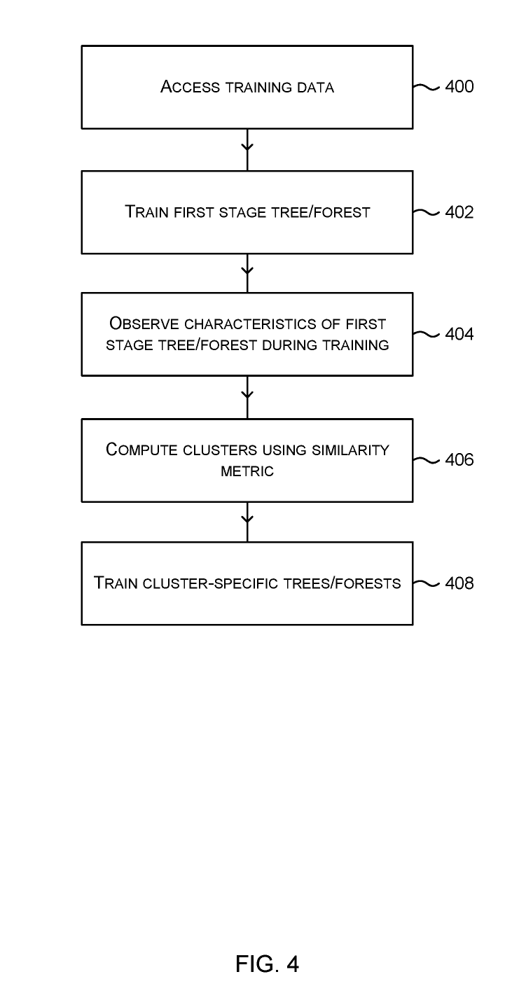

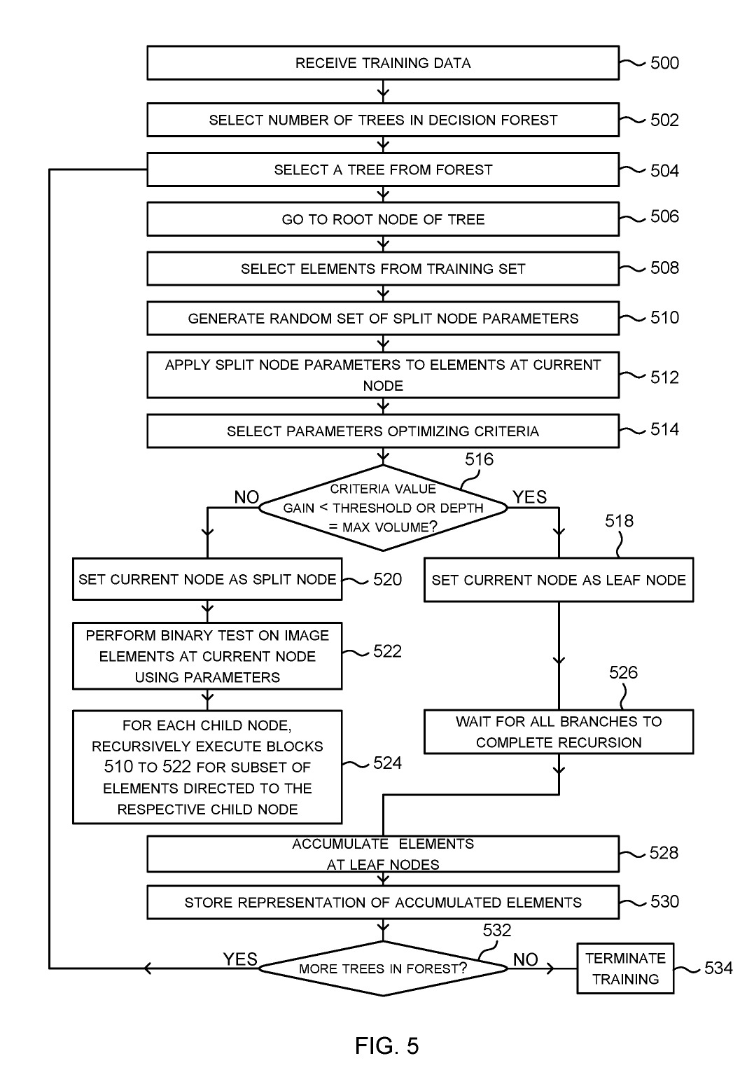

FIG. 4 is a flow diagram of a computer-implemented method of training a cascaded random decision tree architecture. Training data is accessed 400 such as medical images which have labels indicating which body organs they depict, speech signals which have labels indicating which phonemes they encode, depth images which have labels indicating which gestures they depict, or other training data. A first level random decision tree is trained 402 using the accessed training data. Detail about this training process is described below with reference to FIG. 5. Characteristics of the first level random decision tree during the training process are observed 404. For example, the characteristics are pathways of the training data examples through the random decision forest. The characteristics may also include features of the training examples and/or predictions computed by the first level random decision tree.

Clusters are computed 406 using a similarity metric which takes into account similarity of pathways in the first level random decision tree. Various different similarity metrics may be used as described above. To compute the clusters the training examples are passed through the first level random decision tree and, for each pair of training examples, the similarity metric is computed. A clustering algorithm is then used to group together training examples which have similar values of the computed metric. For example using a k-means clustering process or any other clustering process. In an example the k-means clustering process comprises choosing a number of clusters (say 4 for the sake of example) and randomly selecting four of the training examples to be means of the four clusters. Each training examples is assigned to the cluster whose mean yields the least within-cluster sum of squares. The means of the clusters are then updated to be the centroids of the clusters and the training examples are assigned to the updated clusters. The process repeats until there is little change to the clusters. Parameters of the clusters are then calculated and stored, such as a centroid or mean of each cluster.

Once the clusters are available, a cluster-specific random decision tree is trained 408 for each cluster, using the data from that cluster. Where forests are used rather than trees, the process comprises training a cluster-specific random decision forest for each cluster, using the data from that cluster. The method of training the cluster-specific tree or forest is described with reference to FIG. 5.

Referring to FIG. 5, to train the random decision trees, the training set comprising labeled sensor data items is first received 500. The number of decision trees to be used in a random decision forest is selected 502. A random decision forest is a collection of deterministic decision trees. Decision trees can be used in classification or regression algorithms, but can suffer from over-fitting, i.e. poor generalization. However, an ensemble of many randomly trained decision trees (a random forest) yields improved generalization. During the training process, the number of trees is fixed.

A decision tree from the decision forest is selected 504 and the root node is selected 506. A sensor data element is selected 508 from the training set.

A random set of split node parameters are then generated 510 for use by a binary test performed at the node. For example, in the case of images, the parameters may include types of features and values of distances. The features may be characteristics of image elements to be compared between a reference image element and probe image elements offset from the reference image element by the distances. The parameters may include values of thresholds used in the comparison process. In the case of audio signals the parameters may also include thresholds, features and distances.

Then, every combination of parameter value in the randomly generated set may be applied 512 to each sensor data element in the set of training data. For each combination, criteria (also referred to as objectives) are calculated 514. In an example, the calculated criteria comprise the information gain (also known as the relative entropy). The combination of parameters that optimize the criteria (such as maximizing the information gain) is selected 514 and stored at the current node for future use. As an alternative to information gain, other criteria can be used, such as Gini entropy, or the ‘two-ing’ criterion or others.

It is then determined 516 whether the value for the calculated criteria is less than (or greater than) a threshold. If the value for the calculated criteria is less than the threshold, then this indicates that further expansion of the tree does not provide significant benefit. This gives rise to asymmetrical trees which naturally stop growing when no further nodes are beneficial. In such cases, the current node is set 518 as a leaf node. Similarly, the current depth of the tree is determined (i.e. how many levels of nodes are between the root node and the current node). If this is greater than a predefined maximum value, then the current node is set 518 as a leaf node. Each leaf node has sensor data training examples which accumulate at that leaf node during the training process as described below.

It is also possible to use another stopping criterion in combination with those already mentioned. For example, to assess the number of example sensor data elements that reach the leaf. If there are too few examples (compared with a threshold for example) then the process may be arranged to stop to avoid overfitting. However, it is not essential to use this stopping criterion.

If the value for the calculated criteria is greater than or equal to the threshold, and the tree depth is less than the maximum value, then the current node is set 520 as a split node. As the current node is a split node, it has child nodes, and the process then moves to training these child nodes. Each child node is trained using a subset of the training sensor data elements at the current node. The subset of sensor data elements sent to a child node is determined using the parameters that optimized the criteria. These parameters are used in the binary test, and the binary test performed 522 on all sensor data elements at the current node. The sensor data elements that pass the binary test form a first subset sent to a first child node, and the sensor data elements that fail the binary test form a second subset sent to a second child node.

For each of the child nodes, the process as outlined in blocks 510 to 522 of FIG. 5 are recursively executed 524 for the subset of sensor data elements directed to the respective child node. In other words, for each child node, new random test parameters are generated 510, applied 512 to the respective subset of sensor data elements, parameters optimizing the criteria selected 514, and the type of node (split or leaf) determined 516. If it is a leaf node, then the current branch of recursion ceases. If it is a split node, binary tests are performed 522 to determine further subsets of sensor data elements and another branch of recursion starts. Therefore, this process recursively moves through the tree, training each node until leaf nodes are reached at each branch. As leaf nodes are reached, the process waits 526 until the nodes in all branches have been trained. Note that, in other examples, the same functionality can be attained using alternative techniques to recursion.

Once all the nodes in the tree have been trained to determine the parameters for the binary test optimizing the criteria at each split node, and leaf nodes have been selected to terminate each branch, then sensor data training examples may be accumulated 528 at the leaf nodes of the tree. This is the training level and so particular sensor data elements which reach a given leaf node have specified labels known from the ground truth training data. A representation of the accumulated labels may be stored 530 using various different methods. Optionally sampling may be used to select sensor data examples to be accumulated and stored in order to maintain a low memory footprint. For example, reservoir sampling may be used whereby a fixed maximum sized sample of sensor data examples is taken. Selection may be random or in any other manner.

Once the accumulated examples have been stored it is determined 532 whether more trees are present in the decision forest (in the case that a forest is being trained). If so, then the next tree in the decision forest is selected, and the process repeats. If all the trees in the forest have been trained, and no others remain, then the training process is complete and the process terminates 534.

Therefore, as a result of the training process, one or more decision trees are trained using training sensor data elements. Each tree comprises a plurality of split nodes storing optimized test parameters, and leaf nodes storing associated predictions. Due to the random generation of parameters from a limited subset used at each node, the trees of the forest are distinct (i.e. different) from each other.

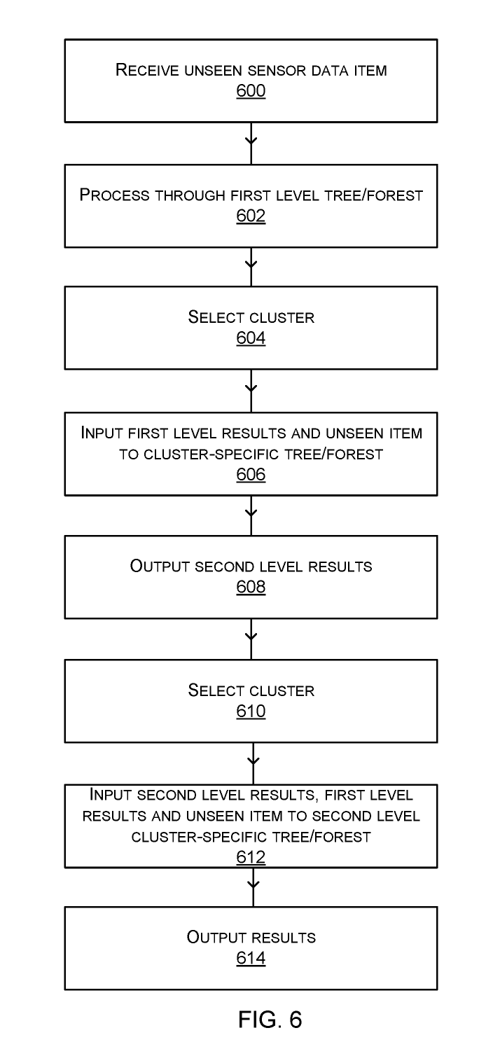

FIG. 6 is a flow diagram of a test time method, of using a trained cascade of random decision trees to compute a prediction. For example, to recognize a body organ in a medical image, to detect a gesture in a depth image or for other tasks. An unseen sensor data item is received 600. The term “unseen” means that the sensor data item 600 was not in training examples used to train a first level random decision tree. The unseen sensor data item is processed 602 through the first level random decision tree or forest which has already been trained as described with reference to FIG. 5. During processing of the unseen sensor data item through the first level tree or forest, features of the unseen sensor data item which are computed during that processing are found. These features are compared with parameters of clusters computed as described above with reference to FIG. 4. For example, the cluster with the closest mean or centroid to the features is selected 604.

A cluster-specific random decision tree or forest is accessed for the selected cluster. This is a random decision tree or forest which has already been trained using the data in the selected cluster.

The first level results (outputs of the first level random decision tree/forest) are input 606 to the selected cluster-specific tree/forest. The unseen item may also be input to the selected cluster-specific tree/forest. The selected cluster-specific tree/forest computes predictions which are referred to herein as second level results 608. The features computed during processing by the first level cluster-specific tree/forest are compared with parameters of second level clusters (which were computed during the training phase). A second level cluster is thus selected 610. The inputs to the second level cluster-specific tree/forest include the second stage results, the first stage results and the unseen sensor data item. The second level cluster-specific tree/forest uses these inputs and computes predictions which are output as results 614.

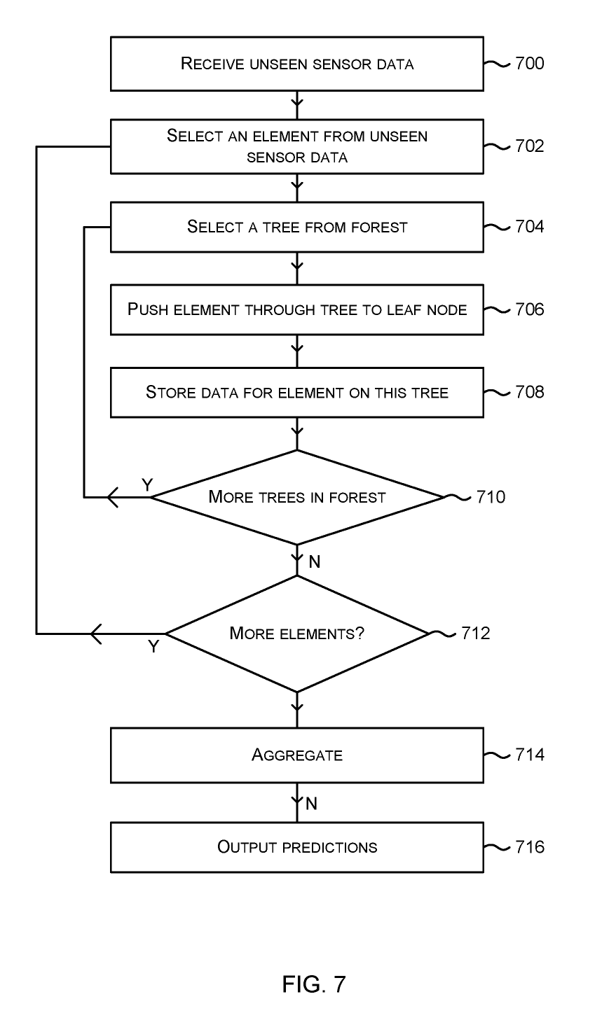

FIG. 7 illustrates a flowchart of a process for computing a prediction from a previously unseen sensor data element using a decision forest that has been trained as described hereinabove. Firstly, an unseen sensor data item such as an audio file, image, video or other sensor data item is received 700. Note that the unseen sensor data item can be pre-processed to an extent, for example, in the case of an image to identify foreground regions, which reduces the number of image elements to be processed by the decision forest. However, pre-processing to identify foreground regions is not essential.

A sensor data element is selected 702 such as an image element or element of an audio signal. A trained decision tree from the decision forest is also selected 704. The selected sensor data element is pushed 706 through the selected decision tree such that it is tested against the trained parameters at a split node, and then passed to the appropriate child in dependence on the outcome of the test, and the process repeated until the sensor data element reaches a leaf node. Once the sensor data element reaches a leaf node, the accumulated training examples associated with this leaf node (from the training process) are stored 708 for this sensor data element.

If it is determined 710 that there are more decision trees in the forest, then a new decision tree is selected 704, the sensor data element pushed 706 through the tree and the accumulated leaf node data stored 708. This is repeated until it has been performed for all the decision trees in the forest. Note that the process for pushing a sensor data element through the plurality of trees in the decision forest can also be performed in parallel, instead of in sequence as shown in FIG. 7.

It is then determined 712 whether further unanalyzed sensor data elements are present in the unseen sensor data item, and if so another sensor data element is selected and the process repeated. Once all the sensor data elements in the unseen sensor data item have been analyzed, then the leaf node data from the indexed leaf nodes is looked up and aggregated 714 in order to compute one or more predictions relating to the sensor data item. The predictions 716 are output or stored.

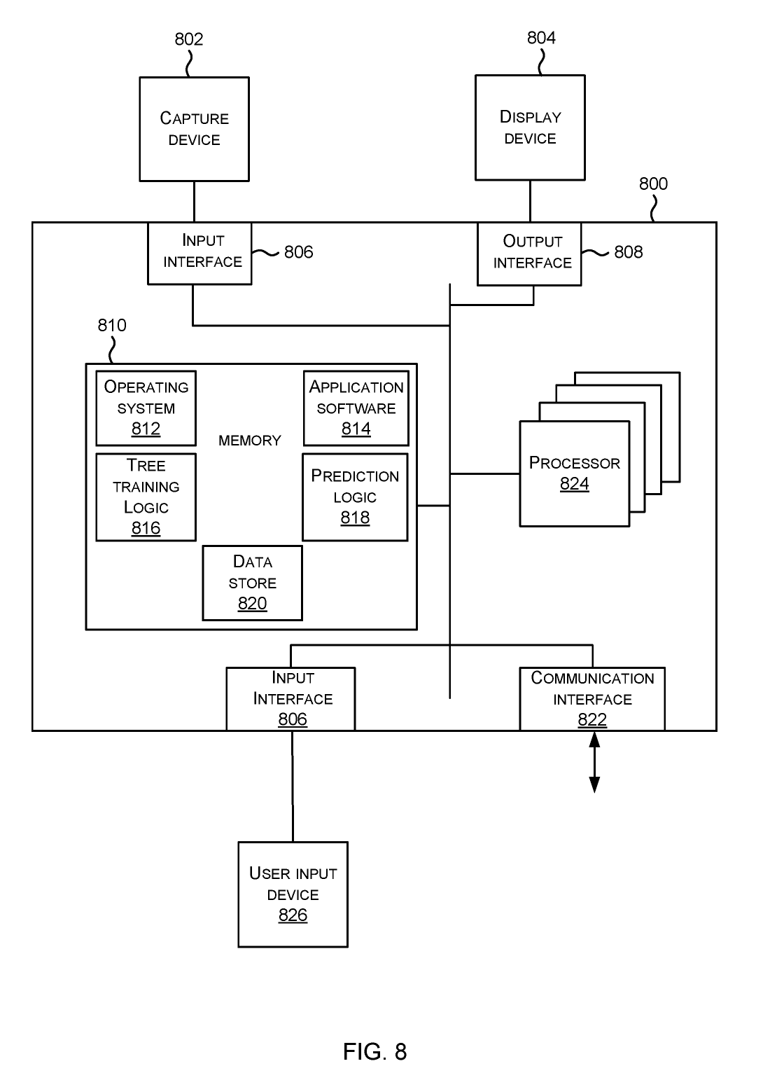

FIG. 8 illustrates various components of an exemplary computing-based device 800 which may be implemented as any form of a computing and/or electronic device, and in which embodiments of cascaded random decision trees/forests may be implemented for medical image analysis, gesture recognition, speech processing and other purposes.

Computing-based device 800 comprises one or more processors 824 which may be microprocessors, controllers, graphics processing units, parallel processing units, or any other suitable type of processors for processing computing executable instructions to control the operation of the device in order to compute predictions from sensor data items. In some examples, for example where a system on a chip architecture is used, the processors 824 may include one or more fixed function blocks (also referred to as accelerators) which implement a part of the method of making predictions from sensor data items in hardware (rather than software or firmware).

The computing-based device 800 comprises one or more input interfaces 806 arranged to receive and process input from one or more devices, such as user input devices (e.g. capture device 802, a game controller, a keyboard and/or a mouse). This user input may be used to control software applications or games executed on the computing device 800.

The computing-based device 800 also comprises an output interface 806 arranged to output display information to a display device 804 which can be separate from or integral to the computing device 800. The display information may provide a graphical user interface. In an example, the display device 804 may also act as the user input device if it is a touch sensitive display device. The output interface may also output data to devices other than the display device, e.g. a locally connected printing device.

The computer executable instructions may be provided using any computer-readable media that is accessible by computing based device 800. Computer-readable media may include, for example, computer storage media such as memory 810 and communications media. Computer storage media, such as memory 810, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Although the computer storage media 1212 (memory) is shown within the computing-based device 104 it will be appreciated that the storage may be distributed or located remotely and accessed via a network or other communication link (e.g. using communication interface 822).

Platform software comprising an operating system 812 or any other suitable platform software may be provided at the computing device 800 to enable application software 814 to be executed on the device. Other software that can be executed on the computing device 800 includes: tree training logic 816 (see for example, FIGS. 4-5 and description above); prediction logic 818 (see for example FIGS. 6-7 and description above). A data store 820 is provided to store data such as sensor data, split node parameters, intermediate function results, tree training parameters, probability distributions, classification labels, regression objectives, classification objectives, and other data.

Alternatively or in addition to the other examples described herein, examples include any combination of the following:

A machine learning system comprising;

a memory storing at least one trained random decision tree and parameters of a plurality of clusters associated with the trained random decision tree;

a processor which pushes a sensor data element through the trained random decision tree to compute a prediction and to obtain values of features associated with the sensor data element, and which selects one of the plurality of clusters by comparing the features associated with the received sensor data element and the parameters of the clusters;

the memory storing at least one cluster-specific random decision tree, which has been trained using data from the selected cluster;

the processor configured to push the prediction through the cluster-specific random decision tree to compute another prediction; and

wherein the clusters group together sensor data elements which give rise to similar pathways when pushed through the trained random decision tree. The term “give rise to” in this context means “results in”. When a sensor data element is pushed through a trained random decision tree it follows a pathway through the tree according to the results of tests at the split nodes as described herein. The pathway is a list of nodes from the root node to a leaf node.

The machine learning system described above wherein the clusters also group together any one or more of: similar values of the features, similar values of the prediction.

The machine learning system described above wherein the similar pathways are found by computing a metric which takes into account the depth of a deepest node of the random decision tree which is common to a pair of pathways through the trained random decision tree.

The machine learning system described above wherein the similar pathways are found by computing a metric which is inversely related to the depth of a deepest node of the random decision tree which is common to a pair of pathways through the trained random decision tree.

The machine learning system of described above wherein the similar pathways are found by computing a metric which is inversely related to two to the power of the depth of a deepest node of the random decision tree which is common to a pair of pathways through the trained random decision tree, where the depth of the deepest node is expresses as an integer number of layers of the random decision forest.

The machine learning system described above where the similar pathways are computed using a metric which takes into account distance between values of the features of a pair of sensor data elements expressed as vectors and concatenated with the associated prediction.

The machine learning system described above where the at least one trained random decision tree is part of a forest stored at the memory and wherein the processor pushes the sensor data element through the trained random decision forest to compute the prediction and to obtain the values of features associated with the sensor data element, and wherein the cluster-specific random decision tree is part of a cluster-specific random decision forest stored at the memory, and where the processor is configured to push the prediction through the cluster-specific random decision forest to compute the other prediction.

The machine learning system described above wherein the sensor data element is an image or part of an image and the prediction is a class label of a class of object that the image is predicted to depict.

The machine learning system described above comprising a training logic which computes the clusters by clustering sensor data elements for which pathways have been observed during passing of the sensor data elements through the random decision forest.

The machine learning system described above wherein the training logic computes the clusters using a metric based on at least similar pathways taken by sensor data elements through the trained random decision.

The machine learning system described above wherein the training logic is configured to train the cluster-specific random decision tree.

The machine learning system described above wherein the memory stores at least one second level cluster-specific random decision tree and parameters of a plurality of second clusters.

A computer-implemented method of operation of a machine learning system comprising;

receiving a sensor data element;

processing, using a processor, the sensor data element through a trained random decision tree to obtain values of features associated with the sensor data element;

selecting one of a plurality of clusters of sensor data elements by comparing the features associated with the received sensor data element and the clusters;

computing a prediction by passing the received sensor data element through a cluster-specific random decision tree, which has been trained using data from the selected cluster;

wherein the clusters group together sensor data elements on the basis of observed pathways when the sensor data elements are process by the trained random decision tree.

The method described above comprising computing the clusters by clustering sensor data elements for which behavior has been observed during passing of the sensor data elements through the random decision forest.

The method described above comprising computing the clusters by, for pairs of sensor data elements, computing a metric which takes into account the depth of a deepest node of the random decision tree which is common to a pathway of each sensor data element of the pair through the trained random decision tree.

The method described above comprising computing the clusters by, for pairs of sensor data elements, computing a metric which is inversely related to the depth of a deepest node of the random decision tree which is common to a pair of pathways through the trained random decision tree.

The method described above comprising training the cluster-specific random decision tree using data from the selected cluster.

The method described above where the at least one trained random decision tree is part of a forest and wherein the cluster-specific random decision tree is part of a cluster-specific random decision forest, and wherein the prediction is computed using the forests.

The method described above further comprising using at least one second level cluster-specific random decision tree and parameters of a plurality of second-level clusters.

A medical image analysis apparatus comprising:

a memory storing at least one trained random decision tree and parameters of a plurality of clusters associated with the trained random decision tree;

a processor which pushes a medical image element through the trained random decision tree to compute a prediction of a class label of a class of objects which the medical image element depicts, and to obtain values of features associated with the sensor data element, and which selects one of the plurality of clusters by comparing the features associated with the received sensor data element and the parameters of the clusters;

the memory storing at least one cluster-specific random decision tree, which has been trained using data from the selected cluster;

the processor configured to push the prediction through the cluster-specific random decision tree to compute another prediction; and

wherein the clusters group together medical image elements which give rise to similar pathways when pushed through the trained random decision tree.

In an example there is a machine learning system comprising:

means for processing a sensor data element through a trained random decision tree to obtain values of features associated with the sensor data element;

means for selecting one of a plurality of clusters of sensor data elements by comparing the features associated with the received sensor data element and the clusters;

means for computing a prediction by passing the received sensor data element through a cluster-specific random decision tree, which has been trained using data from the selected cluster; and

wherein the clusters group together sensor data elements on the basis of observed pathways when the sensor data elements are process by the trained random decision tree.

For example, the means for processing, selecting and computing comprises the prediction logic of FIG. 8 when encoded to carry out the operations of any of FIGS. 6 and 7.

An image processing system comprising;

a memory storing at least one trained random decision tree and parameters of a plurality of clusters associated with the trained random decision tree;

a processor which pushes an image element through the trained random decision tree to compute a prediction and to obtain values of features associated with the image element, and which selects one of the plurality of clusters by comparing the features associated with the received image element and the parameters of the clusters;

the memory storing at least one cluster-specific random decision tree, which has been trained using data from the selected cluster;

the processor configured to push the prediction through the cluster-specific random decision tree to compute another prediction; and

wherein the clusters group together image elements which give rise to similar pathways when pushed through the trained random decision tree.

A computer-implemented method of operation of an image processing system comprising;

receiving an image element;

processing, using a processor, the image element through a trained random decision tree to obtain values of features associated with the image element;

selecting one of a plurality of clusters of image elements by comparing the features associated with the received image element and the clusters;

computing a prediction by passing the received image element through a cluster-specific random decision tree, which has been trained using data from the selected cluster;

wherein the clusters group together image elements on the basis of observed pathways when the sensor data elements are process by the trained random decision tree.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

This acknowledges that software is a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

The term ‘subset’ is used herein to refer to a proper subset such that a subset of a set does not comprise all the elements of the set (i.e. at least one of the elements of the set is missing from the subset).

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

1. A machine learning system comprising;
a memory storing at least one trained random decision tree and parameters of a plurality of clusters associated with the trained random decision tree;
a processor which pushes a sensor data element through the trained random decision tree to compute a prediction and to obtain values of features associated with the sensor data element, and which selects one of the plurality of clusters by comparing the features associated with the received sensor data element and the parameters of the clusters;
the memory storing at least one cluster-specific random decision tree, which has been trained using data from the selected cluster;
the processor configured to push the prediction through the cluster-specific random decision tree to compute another prediction; and
wherein the clusters group together sensor data elements which give rise to similar pathways when pushed through the trained random decision tree.

2. The machine learning system of claim 1 wherein the clusters also group together any one or more of: similar values of the features, similar values of the prediction.

3. The machine learning system of claim 1 wherein the similar pathways are found by computing a metric which takes into account the depth of a deepest node of the random decision tree which is common to a pair of pathways through the trained random decision tree.

4. The machine learning system of claim 1 wherein the similar pathways are found by computing a metric which is inversely related to the depth of a deepest node of the random decision tree which is common to a pair of pathways through the trained random decision tree.

5. The machine learning system of claim 1 wherein the similar pathways are found by computing a metric which is inversely related to two to the power of the depth of a deepest node of the random decision tree which is common to a pair of pathways through the trained random decision tree, where the depth of the deepest node is expresses as an integer number of layers of the random decision forest.

6. The machine learning system of claim 1 where the similar pathways are computed using a metric which takes into account distance between values of the features of a pair of sensor data elements expressed as vectors and concatenated with the associated prediction.

7. The machine learning system of claim 1 where the at least one trained random decision tree is part of a forest stored at the memory and wherein the processor pushes the sensor data element through the trained random decision forest to compute the prediction and to obtain the values of features associated with the sensor data element, and wherein the cluster-specific random decision tree is part of a cluster-specific random decision forest stored at the memory, and where the processor is configured to push the prediction through the cluster-specific random decision forest to compute the other prediction.

8. The machine learning system of claim 1 wherein the sensor data element is an image or part of an image and the prediction is a class label of a class of object that the image is predicted to depict.

9. The machine learning system of claim 1 comprising a training logic which computes the clusters by clustering sensor data elements for which pathways have been observed during passing of the sensor data elements through the random decision forest.

10. The machine learning system of claim 9 wherein the training logic computes the clusters using a metric based on at least similar pathways taken by sensor data elements through the trained random decision.

11. The machine learning system of claim 9 wherein the training logic is configured to train the cluster-specific random decision tree.

12. The machine learning system of claim 1 wherein the memory stores at least one second level cluster-specific random decision tree and parameters of a plurality of second clusters.

13. A computer-implemented method of operation of a machine learning system comprising;
receiving a sensor data element;
processing, using a processor, the sensor data element through a trained random decision tree to obtain values of features associated with the sensor data element;
selecting one of a plurality of clusters of sensor data elements by comparing the features associated with the received sensor data element and the clusters;
computing a prediction by passing the received sensor data element through a cluster-specific random decision tree, which has been trained using data from the selected cluster;
wherein the clusters group together sensor data elements on the basis of observed pathways when the sensor data elements are process by the trained random decision tree.

14. The method of claim 13 comprising computing the clusters by clustering sensor data elements for which behavior has been observed during passing of the sensor data elements through the random decision forest.

15. The method of claim 13 comprising computing the clusters by, for pairs of sensor data elements, computing a metric which takes into account the depth of a deepest node of the random decision tree which is common to a pathway of each sensor data element of the pair through the trained random decision tree.

16. The method of claim 13 comprising computing the clusters by, for pairs of sensor data elements, computing a metric which is inversely related to the depth of a deepest node of the random decision tree which is common to a pair of pathways through the trained random decision tree.

17. The method of claim 13 comprising training the cluster-specific random decision tree using data from the selected cluster.

18. The method of claim 13 where the at least one trained random decision tree is part of a forest and wherein the cluster-specific random decision tree is part of a cluster-specific random decision forest, and wherein the prediction is computed using the forests.

19. The method of claim 13 further comprising using at least one second level cluster-specific random decision tree and parameters of a plurality of second-level clusters.

20. A medical image analysis apparatus comprising:
a memory storing at least one trained random decision tree and parameters of a plurality of clusters associated with the trained random decision tree;
a processor which pushes a medical image element through the trained random decision tree to compute a prediction of a class label of a class of objects which the medical image element depicts, and to obtain values of features associated with the sensor data element, and which selects one of the plurality of clusters by comparing the features associated with the received sensor data element and the parameters of the clusters;
the memory storing at least one cluster-specific random decision tree, which has been trained using data from the selected cluster;
the processor configured to push the prediction through the cluster-specific random decision tree to compute another prediction; and
wherein the clusters group together medical image elements which give rise to similar pathways when pushed through the trained random decision tree.
